(19) United States
(12) Patent Application Publication
(10) Pub. No.: US 2017/0214025 A1
(43) Pub. Date: Jul. 27, 2017

(54) CONTACTING SYSTEM FOR ENERGY STORAGE CELLS AND ENERGY STORAGE DEVICE

(71) Applicant: DIEHL METAL APPLICATIONS GMBH, Berlin (DE)

(72) Inventors: PAUL CZECHANOWSKI, BERLIN (DE); ALEXANDER GOELDNER, BERLIN (DE)

(21) Appl. No.: 15/417,492

(22) Filed: Jan. 27, 2017

(30) Foreign Application Priority Data
Jan. 27, 2016 (DE) 10 2016 000 843.1

(51) Int. Cl. H01M 2/20; H01M 2/10

(52) U.S. Cl. CPC H01M 2/206; H01M 2/1077; H01M 2220/20

(57) ABSTRACT

A contacting system for electrically interconnecting a plurality of energy storage cells of an electrical energy storage device, and an energy storage device such as, for example, a traction battery. The contacting system has cell pole connectors, formed for the electrical interconnection of in each case at least two cell poles of the energy storage cells respectively having at least two cell pole contact elements. At least one of the cell pole connectors has at least one board contact element, which is formed for the contacting of an electronic circuit and is connected in an electrically conducting manner to one of the cell pole contact elements of the cell pole connector by way of a contacting web. The contacting web has at least one web segment extending obliquely in relation to a cell pole contacting plane of the cell pole contact element.

### CROSS-REFERENCE TO RELATED APPLICATION

This application claims the priority, under 35 U.S.C. §119, of German patent application DE 10 2016 000 843.1, filed Jan. 27, 2016; the prior application is herewith incorporated by reference in its entirety.

### BACKGROUND OF THE INVENTION

### Field of the Invention

The basic invention relates in particular to a contacting system for energy storage cells, in particular secondary storage cells, of an electrical energy storage device.

Such contacting systems are used for example in the area of electromobility, and can be used in the production of traction batteries for electric vehicles, in particular electric cars, for connecting a number of battery cells of the traction battery to one another in series.

By way of example, contacting systems are described in the following publications: US 2013/0244499 A1 (EP 2 639 857 A1), DE 10 2011 079 895 A1 or U.S. Pat. No. 9,126,039 B2 (DE 10 2011 076 624 A1). The cited documents show and describe in each case specific solutions for contacting systems in the case of traction batteries, but certainly leave room for improvements with regard to the complexity of production and assembly and/or production costs.

### SUMMARY OF THE INVENTION

It is accordingly an object of the invention to provide a contacting system for energy storage cells, in particular for traction batteries, and also an energy storage device, in particular a traction battery which overcome the above-mentioned and other disadvantages of the heretofore-known devices and methods of this general type and which achieve reduced complexity of production and assembly and/or reduced production costs, in particular. It is a further object to provide a contacting system and an energy storage device which for example make reliable contacting and/or a reliable operation of the energy storage device possible.

With the foregoing and other objects in view there is provided, in accordance with the invention, a contacting system for the electrical interconnection of a plurality of energy storage cells of an electrical energy storage device, the contacting system comprising:
a plurality of cell pole connectors formed for electrically interconnecting in each case at least two cell poles of the energy storage cells;
each of the cell pole connectors having a least two cell pole contact elements defining a cell pole contacting plane;
at least one of the cell pole connectors including at least one board contact element for contacting an electronic circuit, and a contacting web connecting the at least one board contact element in an electrically conducting manner to one of the contact elements of the cell pole connector;
the contacting web including at least one web segment extending obliquely in relation to the cell pole contacting plane of the cell pole contact element.

The features and combinations of features according to the basic invention that are described herein are not restricted by the combination(s) of features chosen in the patent claims and the chosen dependency references. Each feature of one category of claim, for example a device, may also be claimed for example in another category of claim, for example a method. Furthermore, even independently of the respective dependency reference according to the patent claims, each feature in the patent claims may be claimed for example in any desired combination with one or more other feature(s) of the patent claims or of the description that follows. Furthermore, each feature that is described or disclosed in the description that follows and/or the appended drawings may be claimed in itself, independently of or in isolation from the context in which it is given, on its own or in any combination with one or more other features that is or are described or disclosed in the patent claims, the description and/or in the drawings.

In accordance with the invention, there is provided a contacting system for the electrical interconnection of a number of energy storage cells of an electrical, for example electrochemical, energy storage device. The storage cells may be for example secondary batteries or secondary battery cells. The energy storage device may be formed or designed for example as a traction battery for electric vehicles, in particular electric cars.

According to the invention, the corresponding contacting system may comprise a number of cell pole connectors, formed for the electrical interconnection of in each case at least two cell poles of the energy storage cells.

For example, the contacting system may be formed in such a way that the energy storage cells of the energy storage device are or have been connected in series by the cell pole connectors. The cell pole connectors may be formed and arranged in such a way that each cell pole connector respectively connects in particular two cell poles of opposed polarity, belonging to different energy storage cells. However, it is also possible that one or more, in particular all, of the cell pole connectors are formed or used for the parallel connection of two or more energy storage cells.

According to the invention, each cell pole connector formed for the interconnection of two cell poles respectively has at least two cell pole contact elements or cell pole contact portions.

A cell pole contact element is intended to be understood as meaning in particular a portion or element of a cell pole connector which is formed and designed to be connected to a cell pole of an energy storage cell, in particular directly, for example by soldering and/or welding and/or a mechanical connection.

At least one of the cell pole connectors comprises at least one board contact element which is formed and designed for the contacting of an electronic circuit.

The electronic circuit may be for example an electronic circuit formed on a circuit board for controlling and/or monitoring the charging/discharging and/or for monitoring operating states and/or the operation and/or operating parameters of the energy storage cell(s) or of the energy storage device as a whole.

In refinements, all of the cell pole connectors, in particular those cell pole connectors that respectively connect two cell poles electrically to one another, may comprise in each case at least one board contact element, so that controlling, activating and/or monitoring of the respective cell pole or pair of cell poles is possible by way of the board contact element. In variants it is possible that each cell pole contact element of a cell pole connector comprises a board contact element, so that for example each cell pole connected to a corresponding cell pole contact element may be connected to the/a circuit for controlling and/or monitoring etc. Each cell pole may for example be assigned a separate circuit.

The board contact element is connected in an electrically conducting manner to one, for example precisely one, of the cell pole contact elements, of the cell pole connector by way of a contacting web. In particular, the board contact element may be connected in an electrically conducting manner to the cell pole contact element(s) by way of a contacting web at least partially extending between the board contact element and the cell pole connector.

The contacting web and/or the board contact element may for example be formed in a flat-profiled manner, and in particular be produced from a flat-profiled semifinished product, in particular a flat product. The contacting web may for example be formed in the manner of a strip, and the board contact element may for example be formed as a small sheet-like plate. Irrespective of that, the cell pole contact elements may also be produced from a flat-profiled semifinished product, in particular a flat product, for example by a punching and/or forming process.

According to the invention, the contacting web comprises at least one web segment extending obliquely in relation to a cell pole contacting plane of the cell pole contact element.

The oblique extent may for example be made to correspond to a predetermined angle of inclination. The angle of inclination may for example be defined between a longitudinal axis of the web segment and the normal vector of the cell pole contacting plane that extends in the direction of the web segment.

In refinements, the obliquely extending web segment may for example be designed and aligned in such a way that the longitudinal axis of the web segment is inclined with respect to the normal vector of the cell pole contacting plane by an acute angle, i.e. by an angle of less than 90 degrees. The acute angle may for example lie in the range from 20 to 80 degrees, in the range from 30 to 60 degrees, or be less than or around 45 degrees. In particular, such angles have proven to be particularly advantageous with regard to compensating for tensile, compressive and/or torsional stresses between the cell pole contact element and the board contact element, in particular for the operating loads that usually occur during operation in the case of traction batteries.

As described, the web segment of the contacting web may be formed and aligned in such a way that it, or the extension thereof in the longitudinal direction, intersects at an obtuse angle a cell pole contacting plane defined by the cell pole contact element, in particular a cell pole contacting plane defined by a cell pole contacting surface of the cell pole contact element, and to this extent extends obliquely in relation to the cell pole contacting plane according to the description above. An oblique extent is intended to mean in particular that the web segment extends neither entirely parallel nor entirely perpendicular to the cell pole contacting plane.

Within the context of this invention, the term “cell pole contacting surface” of a cell pole contact element is to be understood as meaning in particular a contact surface which, given proper contacting, is in electrical contact with a cell pole, or by way of which contacting, in particular direct electrical contacting, with a cell pole is or can be established. A cell pole contacting surface may for example lie on a corresponding opposing surface of the cell pole and be electrically connected to it.

The term “board contact element” is intended to be understood within the context of the invention described herein as meaning in particular a contact element which makes it possible that the respective cell pole contact element can be connected in an electrically conducting manner to an electrical contact or contact element of a monitoring and/or control board, wherein the board is connected to the contacting system, or may be a component part of the same.

The board may in particular be connected to the contacting system by being integrated, i.e. fixedly soldered by way of the board contact elements.

Furthermore, the board may be mechanically connected to the supporting frame by connecting elements, in particular non-positive or positive connecting elements.

The term “integrated” is intended to mean in particular that the cell contacting system including the board can be made available to the production process for an energy storage device, for example a traction battery, as a unified structural part, or can be processed or used in the production process as a unified structural part.

In particular, the board may be connected in an electrically conducting manner to the cell pole connectors, in that electrical contacts of the board, i.e. board contacts, are electrically connected to one another by corresponding, in particular congruently arranged, board contact elements.

In addition to the electrical integration of the board, the latter may, as mentioned, also be mechanically connected to the supporting frame by mechanical contact elements, i.e. fastening elements.

Electrical contacts between cell poles and cell pole contact elements or between corresponding contact surfaces, or between the board contact element and corresponding contacts of the board, i.e. board contacts, or corresponding contact surfaces, may for example be established by, or at least formed on the basis of, material-bonding and/or non-positive connections such as soldering, welding etc.

Within the context of the invention described herein, a contacting plane is intended to be understood as meaning in particular a plane which is defined by an assigned contacting surface that is formed or provided for the purpose of the electrical contacting of a further contacting surface or with a contact element.

The contacting web may for example be formed in practice as a contact strip, which is for example formed flat in cross section, wherein the width thereof measured transversely to the longitudinal axis, i.e. the width measured transversely to the extent in the direction from the cell pole contact element to the board contact element, is less than a width of the cell pole contact element and/or of the board contact element measured in a corresponding, parallel direction. In this way it can on the one hand be achieved by the increased width of the board contact element that it can be electrically contacted comparatively easily, and positioning in relation to electrical contacts of the board, i.e. in relation to the board contacts, is comparatively easy. It can on the other hand be achieved by the reduced width of the contacting web that the contacting web has sufficiently resilient or spring-elastic properties, by which for example sufficient compensation for compressive, tensile and/or torsional stresses can be achieved.

In refinements, the contacting web may have in its longitudinal direction one or more curvatures or bends, in particular opposed to one another, and may for example have a wave-form and/or meandering extent. The contacting web may in particular be formed in such a way that under tensile, flexural or torsional stresses the board contact element can move and/or can twist spring-elastically in relation to the cell pole contact element, in order in this way to be able in particular to compensate for relative movements and/or (dimensional) tolerances.

It is found in particular that on the one hand a spring-elastic electrical attachment of the board contact element to the cell pole contact element is possible by the proposed web segment of the contacting web, so that mechanical clamping, bracing and/or twisting stresses possibly occurring during the operation and/or the assembly of a corresponding energy storage device can be compensated. Furthermore, as also described even more specifically further below, the web segment may on the other hand also be used for supporting and/or positioning the board to be contacted by way of the board contact elements, wherein the web segment may for example be formed as a kind of abutment and/or rest for the board.

It is consequently found that on the one hand reliable operation of a corresponding energy storage device, and on the other hand simplified assembly, at least with regard to the board of the contacting system that is to be assembled and contacted, can be achieved by the proposed setup. It should be pointed out in particular in this connection that, in the case of the contacting system proposed herein, an assigned control and/or monitoring board, i.e. a board with control and/or monitoring electronics implemented on it, can be integrated comparatively easily. The board may be an integral component part in the ready-produced contacting system, in particular with regard to the electrical and/or mechanical attachment, so that the assembly of the contacting system as a whole on energy storage cells can be carried out in a comparatively easy way.

It may be provided in refinements that the board contact element is formed as a small plate, wherein the board contact element may for example have a flat, planar, or curved, in particular conical geometry or form. In variants, the board contact element may have a rectangular, square or oval board contacting surface or base area.

In refinements, the board contact element, in particular the or a board contacting surface of the board contact element, may at least partially or in certain portions be at a distance from the cell pole contacting plane, in particular at a predetermined distance.

At least one portion of the board contact element may be formed and arranged in such a way that it is at a distance from the cell pole contacting plane, in particular at a predetermined distance.

In particular, the board contact element may be formed and designed in such a way that it is aligned or situated substantially parallel, in particular genuinely parallel, to the cell pole contacting plane. For example, the board contact element may lie at a level that is at a distance from the cell pole contact plane of the cell poles of the energy cells, in particular a level that is at a distance in the direction of the normal to the cell pole contact plane.

A comparatively compact type of construction can be achieved under some circumstances by suitable arrangement and forming of the contact planes. For example, given a sufficient predetermined distance of the board contact plane from the cell pole contact plane, electronic structural elements located on the board can be arranged on a side that is facing the board contact element, so that the structural elements can be arranged lying in an intermediate space that is formed between the board and the energy storage cells and, when considered from the outside, can be covered over by the board.

It may be provided in refinements that the board contact element and the contacting web, or at least major parts thereof, are formed on a side that is facing away from a cell pole contacting surface of the cell pole element, or extend in the direction of this side. In the case of a ready-assembled energy storage device, for example in the form of a traction battery, the said side may for example form the upper side, wherein the board contact elements may be formed in such a way that the board to be contacted and assembled is situated on the upper side. In particular, with such an arrangement, comparatively easy production can be achieved, in that for example the board is placed onto the board contact elements from the upper side, for example positioned in a holding frame, and connected to the said elements, and the contacting system is placed with the cell pole contacting surfaces of the cell pole contact elements that are situated on the underside onto the cell poles of the energy storage cells.

It may be provided in further refinements that the board contact element and the contacting web, or at least part of the contacting web and/or of the board contact element, extend when considered in plan view, i.e. in plan view with respect to the cell pole contacting plane, outside the cell pole contact element. In other words, this means that, when considered in projection with respect to the cell pole contacting plane, the contacting web and/or the board contact element overlap at most partially, in refinements not at all. In particular in such refinements, it can be achieved that the board to be connected at or to the board contact elements is sufficiently far removed in the lateral direction from the cell pole contact elements that the respective cell pole contact element is arranged easily accessibly, in order to be able to connect it for example in a respective welding or soldering operation comparatively easily to an assigned cell pole, and/or in order to protect the board during the soldering and/or welding operation from detrimental thermal loading occurring during the connecting operation.

It may be provided in refinements that the contacting web and the board contact element connected thereto extend in a direction transverse, in particular perpendicular, to the connecting line of two adjacent cell pole contact elements, in particular transverse or perpendicular to the connecting line of the centroids of two adjacent cell pole contact elements of the respective cell pole connector. An orientation of the contacting web and of the board contact element connected to the end thereof, or of the board contact element extending from the end of the contacting web, in a direction transverse to the said connecting line, along which or parallel to which for example the cell poles to be connected may be arranged, makes possible in particular an advantageous setup of the contacting system. Furthermore, the proposed arrangement makes it possible when the electrical connections are being established, for example by soldering or welding, to avoid for example excessively subjecting adjacent contact elements or already established electrical contacts to thermal energy.

In accordance with an added feature of the invention, the contacting web is formed in one piece with at least one cell pole contact element of the respective cell pole connector. In further refinements, the contacting web may be formed in one piece with the respective board contact element. In particular, a respective cell pole contact element, or the cell pole connector, of the respectively assigned contacting web, and also the respective board contact element may be configured in a one-piece, in particular integrated, type of construction. For example, the three components mentioned, i.e. the contacting web, the board contact element and the cell pole contact element, may be produced, for example punched out, from a flat product, in particular a metal sheet, in a one-piece type of construction.

The form of the contacting web, in particular the extent of the web portion extending obliquely in relation to the cell pole contacting plane, and/or the final shape of the cell pole connector may be produced or created for example in a forming step.

Forming the cell pole connector in one piece makes it possible in particular to reduce the number of electrical connections that are respectively required and have to be established, for example soldered or welded connections, whereby for example the complexity of the production can be reduced and the functional reliability of the contacting system can be improved.

In accordance with a further feature of the invention, the contacting web may comprise or have two or more, i.e. at least two, web segments aligned or extending obliquely in relation to the cell pole contacting plane, for example approximately parallel to one another. The two web segments may for example have, form or be a component part of a U-shaped profile in sections perpendicular to the cell pole contacting plane. In the case of a U-shaped profile, the base of the profile may for example be formed as straight or curved, in particular of a wave form. The web segments extending obliquely in relation to the cell pole contacting plane may for example form the legs of the U-shaped profile, and may be connected to one another by way of a straight or curved, in particular wave-form base. Such a geometry of the contacting web is of advantage in particular for sufficiently compensating for tensile or compressive stresses and/or torsional stresses that may occur between the board contact element and the cell pole contact element in the assembled state during use of a corresponding energy storage device.

In further refinements, the contacting web may for example be of a wave form, with for example at least one wave crest and at least one wave trough.

The web segment may be formed as substantially S-shaped or have or be a component part of a corresponding S-shaped portion.

In particular with the refinements previously described, but also with the further refinements described herein, of the contacting web, it is possible to compensate in an advantageous way for mechanical stresses such as tensile, compressive and/or torsional loads that may occur for example equally in a number of dimensions, so that it is possible at least to a great extent to compensate for or intercept mechanical loads and detrimental effects between cell poles and cell pole contacting elements and/or electrical connections, for example soldered or welded connections, that are formed between board contact elements and the contact elements of the board, i.e. between the board and the cell pole contact elements.

In refinements, the at least one web segment may have, in particular in sections perpendicular to the cell pole contacting plane, a substantially straight extent, and/or the at least one web segment may be a component part of a web portion of the contacting web that is curved in an S-shaped manner or is of a wave form. For example, the web segment may be connected at longitudinal ends on both sides to oppositely curved transitional portions. A correspondingly formed contacting web has proven to be particularly advantageous, in particular with regard to compensating for torsional, tensile or compressive stresses.

In refinements, the contacting system may be formed in such a way that two, in particular adjacent, cell pole contact elements of at least one cell pole connector, optionally or preferably all of the cell pole connectors of the contacting system, in a respectively one-piece form are connected to one another by way of a wave portion that is formed to compensate for tensile and/or flexural and/or torsional stresses of the cell pole connector. In other words, the transition between the cell pole contact elements may be of a wave form, with at least one wave. At least one cell pole connector, preferably all of the cell pole connectors, may be designed such that it/they in a one-piece form respectively comprise(s) two cell pole contact elements and one wave portion connecting the cell pole contact elements.

In refinements, the wave portion may for example comprise at least one wave crest and/or at least one wave trough. In refinements, the wave portion may be shaped in such a way that it is formed substantially completely on a side of the cell pole connector that is facing away from the cell pole contacting surfaces of the cell pole contact elements. In particular in this way the cell pole connectors can be placed unhindered onto the cell poles and be connected to them.

It may be provided in refinements that cell pole contacting surfaces or corresponding cell pole contacting planes of the cell pole contact elements of at least one cell pole connector, optionally all of the cell pole connectors, are situated in a common cell pole contacting plane. In other words, the cell pole contact elements may be formed in such a way that their cell pole contacting surfaces, i.e. those surfaces that are/have been electrically connected to the cell poles, lie substantially in one plane, i.e. are coplanar.

The arrangements proposed herein can be put into practice in particular if for example all of the cell pole contact elements of the contacting system that for example connect two cell poles to one another in series have the same geometry.

It may be provided in refinements that board contacting surfaces, i.e. in particular electrical contact surfaces of the board contact elements, that can be or have been connected in an electrically conducting manner to corresponding electrical contact surfaces of a board, of at least two board contact elements are situated in a common board contacting plane.

In particular, the board contacting surfaces of all of the board contact elements may be situated in a common board contacting plane. In this way it is possible for example for comparatively easy attachment and contacting of the board to be achieved.

In refinements, the cell pole contacting plane and the board contacting plane, or corresponding surfaces, may extend genuinely parallel to one another. An arrangement of the contacting planes in relation to one another that is formed in particular as described makes it possible in particular to achieve advantages with regard to establishing the electrical contacts between surfaces that are to be contacted with one another.

In accordance with an additional feature of the invention, the contacting system may be formed in such a way that the web segment has an abutting surface, in particular facing away from the respective cell pole contact element, for the abutment of a board connected to the board contact element, for example a side edge of the board, or a holding frame of the board, or some other component of the contacting system. In the case of such refinements, the web segment may be used as an assembly aid and/or as a positioning and/or holding element or aid, wherein satisfactory compensation for mechanical tensile, compressive and/or torsional stresses is possible at the same time.

In refinements, the web segment may comprise, at least on a side facing away from the respective cell pole contact element, at least one latching element for locking a or the board that is connected to the board contact element. The latching element may for example be formed and designed in such a way that its latching effect takes place in a direction parallel to the web segment. Consequently, the web segment can be used as an assembly aid and/or for fastening the board. The latching effect or the latching element may for example be formed in such a way that the board, to be more precise the electrical contact element of the board, is pressed in the direction of and onto the board contact element.

It may be provided in refinements that the board contact element and/or the web segment is/are designed and formed as (a) supporting element(s) for a or the board connected to the board contact element. In particular, the component parts mentioned may be used for positioning and/or securing the board.

In refinements, the cell pole connector may be formed as a number of layers, and for example comprise at least two layers of material, in particular that are substantially parallel or aligned parallel. Correspondingly, the cell pole contact elements of the cell pole connector may be formed as a number of layers, and correspondingly comprise at least two layers of material. The layers of material may for example lie directly against one another.

In refinements, in particular with the cell pole connector or cell pole contact element formed as a number of layers, the contacting web may be connected, for example in one piece, to that layer of material which, given proper electrical connection of the cell pole connector, is connected directly to the cell poles of the energy storage cells. In particular, the contacting web may be formed on that layer of material that lies directly on the contact surfaces of the cell poles. The corresponding layer of material may for example comprise or define the cell pole contacting surface.

Forming the contacting web on the layer of material that is directly connected to the cell pole can achieve the effect that operating parameters of the respective cell poles or cell poles connected to another can be reliably recorded.

A multi-layered setup may be used in particular to achieve the respectively required bending and/or twisting capability, with at the same time for example a high resistance to voltage and current of the cell pole contact elements. Multi-layered cell pole contact elements may for example be used in the case of contacting systems for energy storage devices in the high-voltage range of for example up to 400 V. Such energy storage devices may be used for example in the area of electromobility for traction batteries and the like.

The cell pole connector may be produced for example from copper, aluminium, an alloy, in particular of the metals mentioned, or a composite material comprising a number of conductor materials. If required, the cell pole connector may be coated, at least on electrical contacting surfaces, for example to improve the durability and/or quality and/or ageing resistance of soldered and/or welded connections etc.

In refinements of the contacting system, it may further comprise a supporting frame, to which the at least one cell pole connector, and possibly the board, is/are mechanically fastened.

The supporting frame may for example be produced from a plastics material or a plastic-metal composite, and may for example comprise an outer frame and an inner frame, with for example webs and the like arranged in the manner of a grid, for the assembly of the cell pole connectors and/or the board.

In refinements, the cell pole connector may comprise a fastening component that is formed for fastening to the supporting frame. The fastening component may for example be formed for positive and/or non-positive connection to the supporting frame.

The fastening component may be formed in one piece with the cell pole connector and/or at least one cell pole contact element of the cell pole connector.

The fastening component may be formed as an integrated component part of the cell pole connector, in particular of a cell pole contact element. In variants, each of the cell pole contact elements of a cell pole connector may comprise at least one fastening component or a fastening element.

In refinements, the fastening component, or the fastening element, may have at least one through-hole, in particular aligned perpendicularly to the cell pole contacting plane or perpendicularly to the cell pole contacting surface. By means of the through-hole, the cell pole connector can be connected to the supporting frame, for example by a riveted connection and/or a caulking, in particular in the case of a supporting frame produced from plastic.

The through-hole or the fastening component may for example be formed in the cell pole contact element, in particular at or in the vicinity of a side edge or corner edge of the cell pole contacting element that is facing the contacting web.

Preferably, the fastening component, in particular the through-hole, is arranged in such a way that it has in the transitional region of the contacting web and the cell pole contact element a predetermined distance, in particular a lateral distance when considered in the direction of the longitudinal extent of the contacting web, from the transitional region, so that sufficient mechanical stability for the cell pole contact element can be achieved in spite of the fastening component and/or advantageous contact resistances between the cell pole contact element and the contacting web can be achieved in spite of the fastening component.

In refinements, on a side or side edge that is facing away from the fastening component, in particular the through-hole, the cell pole connector may be in engagement by means of at least one latching element formed on the supporting frame, for example a latching lug or a latching groove. In this way, the cell pole contact elements can for example be assembled in a comparatively easy way, in that the cell pole contact elements are first inserted into the latching element, and then fixedly connected, in particular integrally connected, to the supporting frame by means of the fastening component.

In refinements, the supporting frame may have a supporting element, i.e. at least one supporting element, for at least one board contact element, preferably for each board contact element. The supporting element may for example comprise at least one supporting projection, which projects from the supporting frame in the direction of the assembled board contact element, and to this extent may act as a kind of rest for the board contact element and any board that may be assembled on it.

In particular, a/the supporting element may be formed in such a way, and the board contact element may be aligned and positioned in such a way, that the board contact element is supported or lies with a side facing away from the board contacting surface of the board contact element on the supporting element.

For example, the board contact element in the assembled state may be supported with a surface that is facing the supporting frame on a/the supporting element, wherein the board contacting surface may be arranged or formed on the side facing away from the supporting frame.

In particular in the case of refinements with a supporting element, it is possible first to assemble the cell pole connectors on the supporting frame, and then to place the board on such that electrical contact surfaces of the board lie on the board contacting surfaces and are in electrical contact with them. In the case of the refinements described, one and the same direction of assembly, for example approximately parallel to the direction normal to the surface defined by the supporting frame, can be achieved for example for the assembly of the cell pole contact elements and the board on the supporting frame.

It may be provided in refinements of the contacting system that the contacting system comprises at least one row of cell pole connectors, which has in each case a number of cell pole connectors arranged parallel to a longitudinal axis of the contacting system and situated one behind the other. The cell pole connectors of a row of cell pole connectors may for example be aligned in such a way that connecting lines of the cell pole contact elements of the cell pole connectors are in each case oriented parallel to the longitudinal axis of the row of cell pole connectors, in particular parallel to the longitudinal axis of the contacting system. In particular in such refinements, a number of energy storage cells, for example of a vehicle traction battery, can be connected in series.

In refinements, the cell pole connectors of a row of cell pole connectors may be aligned in such a way that the unit formed by the contacting web and the board contact element extends transversely, in particular perpendicularly, to the longitudinal axis of the row of cell pole connectors and/or of the contacting system.

In refinements, rows of cell pole connectors for example may be formed in pairs, wherein each pair of rows of cell pole connectors may for example be assigned a control and/or monitoring board. For example, the cell pole connectors of a pair of rows of cell pole connectors may be aligned in such a way that the board contact elements of the one row of cell pole connectors are facing the board contact elements of the other row respectively of cell pole connectors. In particular in the case of such an arrangement and alignment of the board contact elements, the board may be arranged between the rows of cell pole connectors of one pair of rows of cell pole connectors. In the case of the refinements mentioned, a comparatively compact form of construction can be achieved, particularly with regard to the mechanical setup and electrical contacting.

As already mentioned, in refinements, the contacting system may furthermore have a board, for example with control and/or monitoring electronics. The board may for example comprise a plurality of electrical contacts, i.e contacts attached to or present on a main board body, which are intended to be electrically connected to the board contact elements of the cell pole connector. The number of corresponding electrical contacts of the board may in this case correspond to the number of board contact elements of the cell pole connectors, wherein preferably precisely one electrical contact is provided on the board for each board contact element, i.e. precisely one board contact. Each corresponding electrical contact of the board is preferably directly connected in an electrically conducting manner to a board contact element, for example by means of a material-bonding connection, in particular a soldered connection.

As already indicated, it may be provided in refinements that the board extends parallel to the longitudinal axis of the row of cell connectors and/or of the contacting system. The board may for example extend substantially over the longitudinal extent of the rows of cell connectors. Furthermore, the board may be arranged or positioned between, in particular completely between, two rows of cell pole connectors, wherein board contact elements facing the board are in electrical contact with corresponding electrical contacts of the board. The contacts of the board, i.e. for the purposes of the application the board contacts, may be arranged peripherally on the boards, for example in a row, lying one behind the other, for example in the longitudinal direction of the board. In particular, such refinements make possible in particular a compact, for example flat-formed, setup of the contacting system.

It may be provided in refinements that the board butts with at least one longitudinal edge against the web segments of the respective contacting webs, and/or that the board is at least partially supported on the board contact elements of the cell pole connector by means of the electrical contacts connected to the board contact elements.

In particular if the web segments are used as abutting surfaces and/or if, along with their electrical contacting function, the board contact elements are also used as rests for the board, a comparatively mechanically stable setup can be achieved, wherein advantages with regard to assembly can also be achieved by positioning the board on the abutting surfaces and on rests.

It may be provided in refinements that at least one electrical interface is formed, or is present, at a longitudinal end of the contacting system. The interface may for example comprise at least one plug-in contact element, for example for establishing a power-side connection or for connection to an electronic control and/or monitoring circuit, for example of the board.

Correspondingly, the at least one interface may comprise at least one power and/or control tap, wherein the interface may be formed in such a way that a plug-in direction defined by the interface for the electrically conducting connection to a mating plug-in contact element extends parallel to the longitudinal axis of the contacting system.

With the above and other objects in view there is also provided, in accordance with the invention, an energy storage device, in particular a traction battery for electric vehicles, for example electric cars.

The novel energy storage device comprises a plurality of energy storage cells, which may be for example or preferably electrochemical storage cells, in particular secondary battery storage cells. The energy storage cells comprise in each case cell poles of opposed polarity.

The energy storage device also comprises at least one contacting system corresponding to one of the refinements described herein according to the invention, wherein the cell poles of at least one subset of the energy storage cells are electrically interconnected, in particular connected in series, by means of the cell pole connectors of the contacting system.

For example, n storage cells may be connected to one another by a contacting system using n−1 cell pole connectors, wherein n is a natural number greater than 1. According to a specific example, 16 storage cells may be connected in series by 15 cell pole connectors. Cell poles of the storage cells that are not connected by cell pole connectors, at the end positions in terms of circuitry, may be used for example as/for power taps, or be connected to corresponding power taps.

In refinements of the energy storage device, electrical contact surfaces of the cell poles interconnected by a contacting system may be situated in a common contacting plane. Furthermore, it may be provided in refinements that board contacting surfaces of the board contact elements lie in a common board contacting plane. In particular in the case of such refinements, the contacting plane of the cell poles may for example be situated genuinely parallel to the board contacting plane, wherein the board contacting plane may for example be situated at a distance from the contacting plane of the cell poles, in particular at a predetermined distance, in the direction of the cell pole normal to the cell poles.

In particular, the previously described refinements make possible a comparatively easy assembly of the energy storage device, and allow comparatively easy electrical contacting of the cell poles and the board contacts.

It may be provided in further refinements of the contacting system and of the energy storage device that all of the cell pole connectors that are intended for connecting a number of cell poles, in particular two cell poles, in series have the same geometry. In particular, it is thereby possible to use a single type of cell pole connectors for the purposes of the invention for producing the contacting system, whereby advantages can be achieved in particular in terms of time and cost in production and assembly.

It is found altogether that the contacting system proposed herein and the energy storage device proposed, and the refinements thereof, solve the problem addressed.

Other features which are considered as characteristic for the invention are set forth in the appended claims.

Although the invention is illustrated and described herein as embodied in a contacting system for energy storage cells and energy storage device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows an exemplary embodiment of an energy storage device according to the invention, comprising a contacting system formed as provided by an exemplary embodiment of the invention;

FIG. 2 shows a detail of the energy storage device of FIG. 1 in a partially broken-open representation;

FIG. 3 shows the contacting system of FIG. 1 in a plan view;

FIG. 4 shows the contacting system of FIG. 1 in a front view;

FIG. 5 shows a perspective representation of a cell pole connector;

FIG. 6 shows a side view of the cell pole connector of FIG. 5; and

FIG. 7 shows a partial cross-sectional representation along the line A-A of FIG. 3.

### DETAILED DESCRIPTION OF THE INVENTION

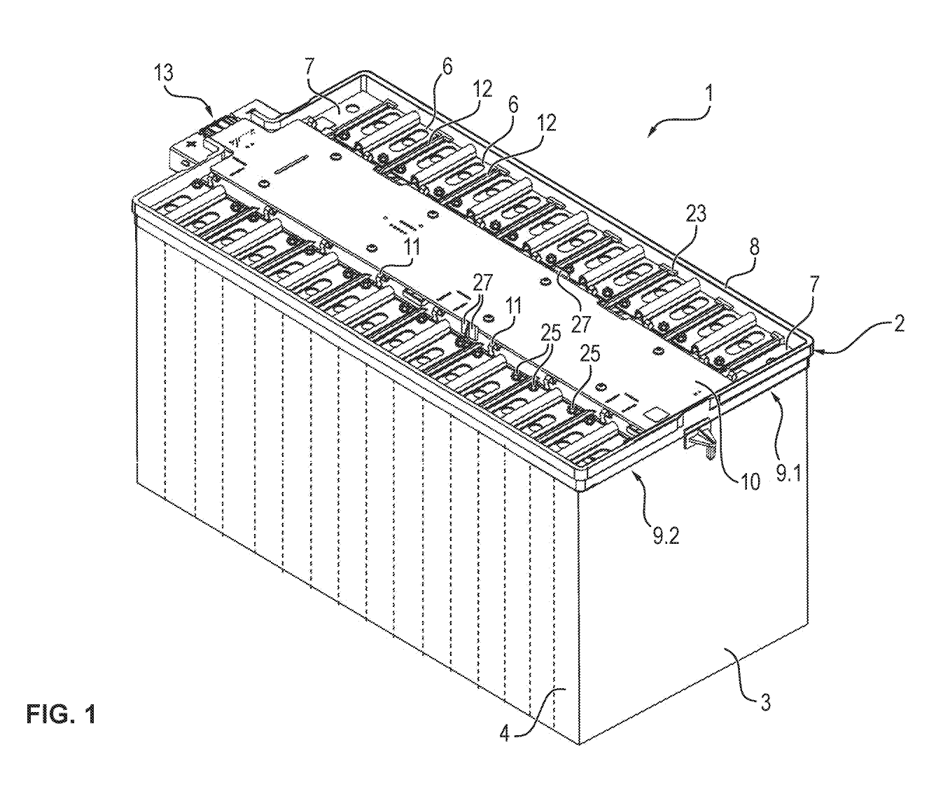

Referring now to the figures of the drawing in detail and first, particularly, to FIG. 1 thereof, there is shown an exemplary embodiment of an energy storage device 1 according to the invention. The device 1 includes a contacting system 2 formed as provided by an exemplary embodiment of the invention.

The energy storage device 1 comprises energy storage cells 4, which are accommodated in a housing 3 and the position of which is indicated in FIG. 1 by dashed lines.

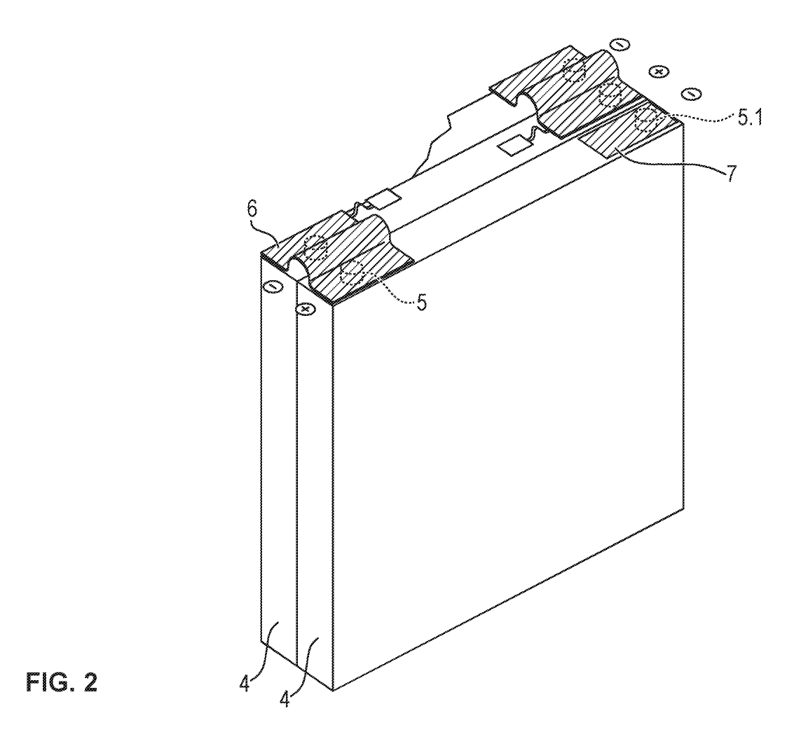

As can be seen in FIG. 2, each energy storage cell 4 comprises two oppositely polarized cell poles 5. The energy storage cells 4 are arranged such that two rows of cell poles with respectively alternating polarity are present. Adjacent cell poles of opposed polarity of a row are connected in pairs by a cell pole connector 6 each, for example in such a way that the associated energy storage cells 4 are electrically connected in series, and cell poles of the energy storage cells 4 that are at the end positions in terms of connection can be contacted for withdrawing power or for tapping power.

At the end cell pole 5.1 shown in FIG. 2 there is a voltage tap 7, by way of which the energy storage device 1 can be electrically contacted for withdrawing power or for charging.

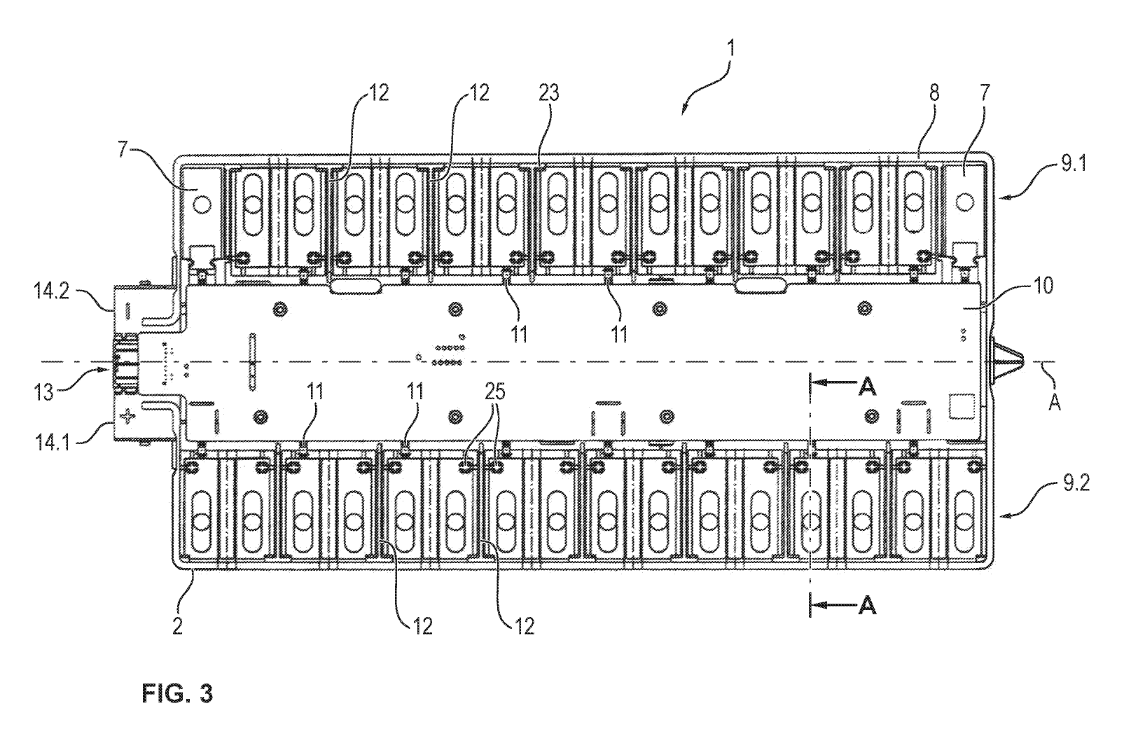

As can be seen in particular in FIG. 1 and also in FIG. 3, the contacting system 2 comprises a supporting frame 8, at or on which substantially all of the components of the contacting system 2 are assembled.

The supporting frame 8 defines a substantially rectangular outer frame, within which substantially all of the components and structural parts are assembled.

Within the outer frame there may extend an inner frame and/or corresponding connecting and/or fastening webs or members, to which for example the cell pole connectors 6 etc. may be fastened or fixed.

As can be seen in particular from FIG. 1 and FIG. 3, the cell poles 5, and correspondingly the cell pole connectors 6, are arranged along two parallel lines, which extend parallel to the longitudinal axis A of the contacting system 2. In particular, a row of cell pole connectors is respectively formed on both longitudinal sides of the contacting system 2 and are identified in FIG. 3 by the designations 9.1 and 9.2.

Arranged midway between the rows of cell pole connectors 9 is a board 10, the electrical terminal contacts of which are connected to contact elements 11 described still more specifically below, to be more precise board contact elements, of the cell pole connectors 6.

The board 10 may for example comprise electronic circuits or components for controlling, for example controlling the charging, monitoring the charge or generally for monitoring the operation of the energy storage device 1, in particular for monitoring operating parameters of the energy storage device 1, in particular of the energy storage cells 4.

Between directly adjacent cell pole contact elements 6 there may be formed in each case insulating and holding webs 12, which may be a component part of the supporting frame 8.

At one end face, the contacting system 2 comprises an electrical interface 13, which may for example be formed at least partially integrally with the board 10. The interface 13 may for example comprise a positive voltage tap 14.1 and a negative voltage tap 14.2, which may be connected to the corresponding positive and negative voltage taps 7 by way of corresponding leads. As can be seen from FIG. 3, the interface 13 may protrude beyond the supporting frame 8, or be formed by an end projection on the supporting frame 8, or else finish substantially flush with the end face.

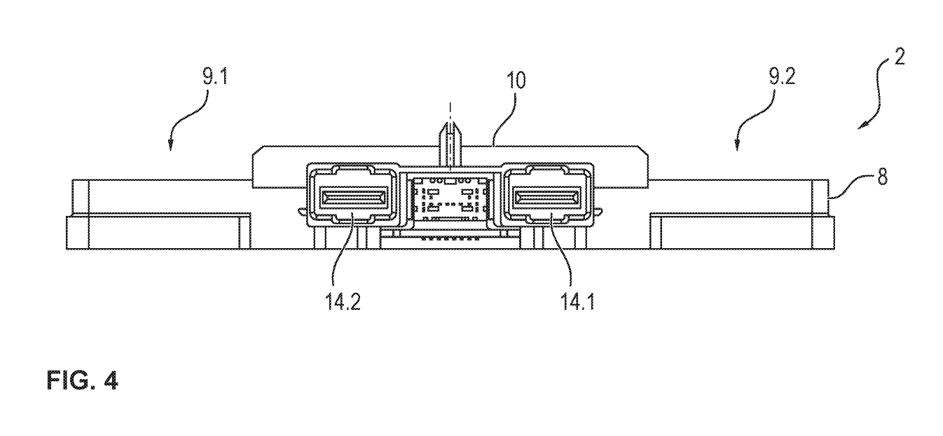

As can be seen for example from FIG. 4, between the voltage taps 14 the interface 13 may also comprise an additional plug-in or connection component, which may for example be connected to electronic components of the board 10 for the purpose of providing a signal tap.

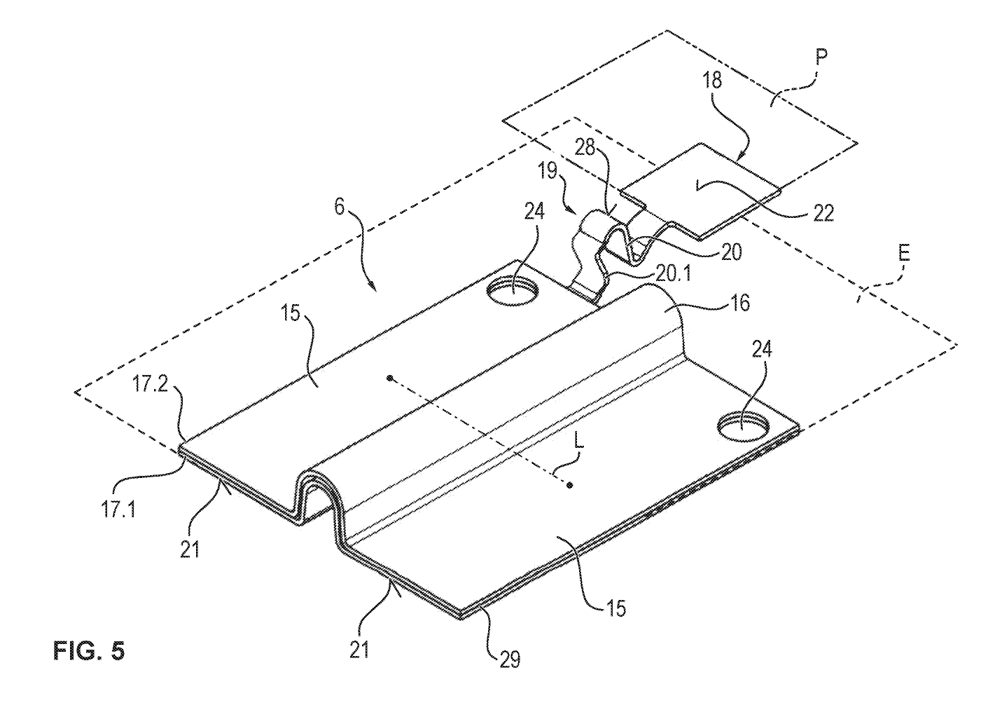

FIG. 5 shows a perspective representation of a cell pole connector 6. As already stated, the cell pole connector 6 is designed to electrically connect two, in the present case oppositely polarized, cell poles 5, for example of adjacent energy storage cells 4, to one another.

The cell pole connector 6 comprises two cell pole contact elements 15, which in the present case are formed in a sheet-like manner, with a rectangular base form. In the example shown, the cell pole contact elements 15 are connected by a compensating structure 16, in the present case in the form of a one-dimensionally bent wave rising up over the cell pole contact elements 15. The wave 16 and the cell pole contact elements 15 are formed in the present case by two parallel layers of material 17.1 and 17.2, wherein each of the layers of material 17 is formed as a one-piece structural part or one-piece component.

The wave or compensating structure 16 serves in the present example for compensating for tensile, compressive and/or torsional stresses that may occur during the operation and use of the energy storage device 1 after connection of the cell pole connectors 6 to the respective cell poles 5.

The compensating structure 16 may be shaped differently than as shown in the figures, and for example have a number of waves, it having been found that cell pole connectors 6 with compensating structures 16 comprising just a single wave can be reliably used in particular in the case of traction batteries for electric vehicles.

The cell pole connector 6 also comprises a board contact element 18, which is designed and formed for the contacting of an electronic circuit, which in the present exemplary embodiment may for example be implemented on the board. The board contact element 18 is connected in an electrically conducting manner to one of the cell pole contact elements 15 of the cell pole connector 6 by way of a contacting web 19.

The contacting web 19 comprises at least one web segment 20 extending obliquely in relation to a cell pole contacting plane E of the cell pole contact element 15.

The cell pole contacting plane E is defined in the present case by the cell pole contacting surface 21 formed on the (under)side of the cell pole contact element 6 that is facing away from the wave 16, wherein the cell pole contacting plane E and the cell pole contacting surface 21 may for example be situated substantially coplanar to one another.

The board contact element 18 is formed in the present example as a small plate with a square base area, though other shapes, in particular surfaces curved once or twice with any desired form of base area also come into consideration.

Preferably, the board contact element 18 has however a width, measured parallel to the cell pole contacting plane E, that is greater than a corresponding width of the contacting web 19, which may be formed as in the example of the figures in the manner of a strip with a curved and/or wave-form structure. In particular in the case of such refinements, it can on the one hand be achieved by the increased width of the board contact element 18 that electrical contacts between the electrical contacts of the board and the board contact elements 18 can be established comparatively easily. On the other hand, a sufficiently resilient, in particular elastically resilient, structure can be obtained by the reduced width of the contacting web 19 making possible for example sufficient compensation for compressive, tensile and/or torsional stresses between the board 10 and the cell pole contact elements 6.

The board contact element 18 has a board contacting surface 22, which is designed in such a way that it can be electrically connected to corresponding electrical contacts of the board 10, i.e. to corresponding board contacts, for example by means of soldering, welding and/or by mechanical connections. In the present example, the board contacting surfaces 22 lie in a common board contacting plane P, which is at a predetermined distance from the cell pole contacting plane E.

In the example of the figures, the board contacting surface 22 is facing away from the cell pole contacting surface 21, i.e. the normal vectors thereof are pointing in opposite directions.

As also becomes clear when considered together with FIGS. 1 to 4, in the present example the board contact element 18, in particular the board contacting surface 22, is at a distance from the cell pole contacting plane E, in particular at a predetermined distance, wherein the board contact element 18 in the present case is aligned substantially parallel to the cell pole contacting plane E. When considered together with FIG. 1, it is found that the intermediate space between the energy storage cells 4 and the side of the board 10 that is facing the energy storage cells 4 can be set in a suitable way by correspondingly choosing the aforementioned distance, so that in the intermediate space there is sufficient space available for electronic structural elements that are accommodated on the board.

It should be mentioned incidentally that, as in the present example, substantially all of the structural parts that are present on the board 10 are formed on the side that is facing the energy storage cells 4, so that at least mechanical protection for these structural parts can be obtained by the rear side of the board.

As in the example shown, the electrical contacts of the board 10 that are to be connected to the board contact elements 18 may be arranged on the side of the board that in the assembled state is facing the energy storage cells 4, so that comparatively easy contacting and positioning of the board 10 on the board contact elements 18 and the supporting frame 8 is possible.

In the example of the figures, the board contact element 18 and the contacting web 19 are formed on a side facing away from a cell pole contacting surface 21 of the cell pole contact element 15, so that even with comparatively low-formed cell poles a comfortable attachment of the cell pole connectors 6 to the cell poles 5 is possible.

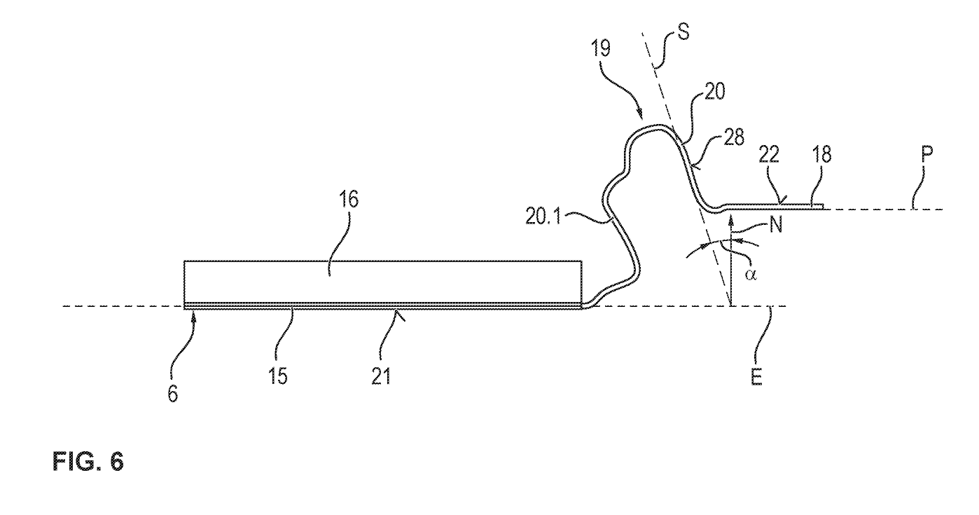

As can be seen in particular from FIG. 6, when considered in plan view, the board contact element 18 and the contacting web 19 extend completely outside the cell pole contact element 15, so that sufficient space is available for the assembly of the cell pole contact elements 15 on the cell poles 5, and the board 10 is at a sufficiently great distance from the cell poles 5 in order to avoid possibly detrimental effects during the connection process, such as for example introduction of thermal energy etc.

However, it may also be provided in refinements, for example depending on the configuration and arrangement of the cell poles 5, that there is to a greater or lesser extent an overlap between the cell pole contact element 15 and the contacting web 19 and/or the board contact element 18.

As can be seen for example from FIG. 6, the web segment 20, and incidentally also the further web element 20.1, run(s) obliquely in relation to the cell pole contacting plane E, wherein the web longitudinal axis S is inclined by an acute angle α, for example of less than 45 degrees or less than 30 degrees, in relation to the normal vector N of the cell pole contacting plane E. The further web element 20.1 may be inclined correspondingly or else with a different angle in relation to the normal vector N.

As in the examples shown, when considered in plan view the board contact element 18 and the contacting web 19 extend substantially perpendicularly from a side edge of the cell pole connectors 6, wherein the side edge extends perpendicularly to the wave 16, i.e. in the present case parallel to the connecting line L of two adjacent cell pole contact elements 15, or parallel to the connecting line L of the centroids of the cell pole contact elements 15, or of the cell pole contacting surface 21 (see FIG. 5).

The previously described geometry, concerning in particular the relative position of the board contact element 18 with respect to the cell pole contact element 15 or the angle α, is of advantage in particular whenever, as in the exemplary embodiment shown, there are a number of parallel rows of cell pole connectors 6 with a board 10 lying in between.

As in the present exemplary embodiment, the contacting web 19 may be formed in one piece with the cell pole contact element 15 and also in one piece with the respective board contact element 18. For example, such a cell pole connector 6 may be produced as a one-piece structural part from a flat product, for example by punching, wherein the contacting web 19 can be formed in a forming step in a way corresponding to the respectively desired shape and oblique alignment of the web segment 20.

As shown in the exemplary embodiment of the figures, the contacting web 19 may comprise two web segments extending obliquely in relation to the cell pole contacting plane E, for example aligned approximately parallel to one another, it being possible for the further web segment 20.1 to be present in addition to the already mentioned web segment 20.

The two web segments 20, 20.1 are connected to one another by way of a connecting element, which in the present case is formed in a curved manner, and form an altogether approximately U-shaped structure, which on the one hand is sufficiently robust, and on the other hand has proven to be advantageous in compensating for compressive, tensile and/or torsional stresses or loads between the board contact element 18 and the cell pole contact element 15.

The curvature of the contacting web 19 may also be formed differently than as shown in the figures. However, an extent of the contacting web 19 has proven to be particularly advantageous in particular for traction batteries for electric vehicles with regard to assembly, the possible compensation for mechanical loads, and with regard to production, in particular in the case of refinements in which the web segment 20, and possibly the further web segment 20.1, have a substantially straight extent, and by way of a connecting element lying in between form a U-shaped structure. The web segments 20, 20.1 may be a component part of a web portion curved in an S-shaped manner.

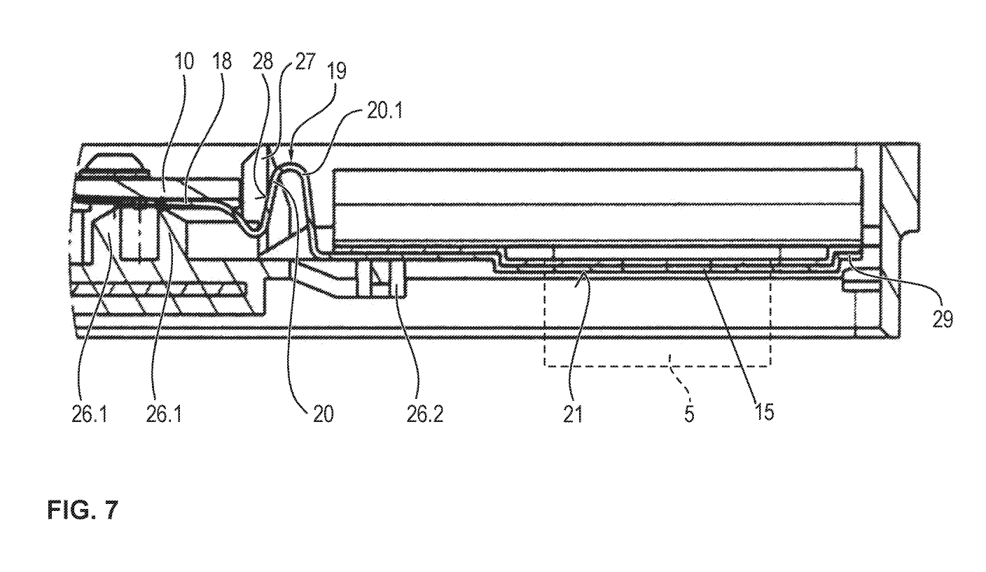

FIG. 7 shows a partial cross-sectional representation along the line A-A of FIG. 3. When FIG. 1 to FIG. 7 are considered together, it is found that the cell pole connector 6 is supported and fastened on the supporting frame 8 by means of the cell pole contact elements 15.

In particular, at a side edge away from the contacting web 19, the cell pole connector 6 may be locked in a latching element 23, for example a latching groove, of the supporting frame 8, and, at a side edge away from the aforementioned side edge, may be connected to the supporting frame 8 for example by means of two through-holes 24 provided in the cell pole contact elements 15, by using a positive and/or non-positive connection. The through-holes 24 may be used for example for establishing a positive and non-positive connection created by hot caulking 25. The board 10 may likewise be fastened to the supporting frame 8 by way of suitable connections.

As can be seen from FIG. 7, the supporting frame 8 may comprise one or more first supporting elements 26.1 and one or more second supporting elements 26.2, wherein the cell pole contact elements 15 may be supported on the second supporting elements 26.2, for example on a side facing away from the latching element 23. The board contact elements 18 may be supported on the first supporting elements 26.1 on a side facing away from the board contacting surface 22, wherein the first supporting elements 26.1 can consequently serve as a rest for the board contact elements 18 and possibly for the board 10, situated thereover in the view of FIG. 7.

The supporting frame 8 may also have suitable abutting and positioning elements 27 or projections, against which the board 10 can be made to butt in a direction perpendicular to the rows of cell pole connectors 9.1 and. 9.2, so that a suitable positioning of the board 10 in relation to the supporting frame 8 can be achieved.

As an alternative or in addition, the web segment 20 may have an abutting surface 28, which for example faces away from the respective cell pole contact element 15 and serves for example for the abutment of the board 10 or other components in a direction perpendicular to the rows of cell pole connectors 9, for example in the course of the production, assembly and/or positioning of the board 10.

The web segments 20 and/or the abutting and positioning elements 27 may also comprise latching elements for the locking of the board 10 or other components.

As can also be seen in particular from the representation of FIG. 7, the cell pole contact elements 15 are formed as a number of layers, and comprise in the present case two layers of material, wherein the contacting web 19 is connected in one piece to that layer of material 29 which, given proper assembly, is connected to the cell poles 5, i.e. which comprises the cell pole contacting surface 21, with which the cell pole contact element 15 can be connected directly to the respective cell pole 5.

It is found overall that the problem addressed by the invention can be solved by the contacting system proposed herein and the proposed energy storage device.

The following is a summary list of reference numerals and the corresponding structure used in the above description of the invention:
1 Energy storage device
2 Contacting system
3 Housing
4 Energy storage cell
5, 5.1 Cell pole
6 Cell pole connector
7 Voltage tap
8 Supporting frame
9.1, 9.2 Row of cell pole connectors
10 Board
11 Contact element
12 Holding web
13 Interface
14.1, 14.2 Voltage tap
15 Cell pole contact element
16 Compensating structure
17 Layer of material
18 Board contact element
19 Contacting web
20 Web segment
20.1 Further web segment
21 Cell pole contacting surface
22 Board contacting surface
23 Latching element
24 Through-hole
25 Hot caulking
26 Supporting element
27 Abutting and positioning element
28 Abutting surface
29 Layer of material
A Longitudinal axis
E Cell pole contacting plane
L Connecting line
N Normal vector
P Board contacting plane
S Web longitudinal axis
α Angle

1. A contacting system for the electrical interconnection of a plurality of energy storage cells of an electrical energy storage device, the contacting system comprising:
a plurality of cell pole connectors formed for electrically interconnecting in each case at least two cell poles of the energy storage cells;
each of said cell pole connectors having a least two cell pole contact elements defining a cell pole contacting plane;
at least one of said cell pole connectors including at least one board contact element for contacting an electronic circuit, and a contacting web connecting said at least one board contact element in an electrically conducting manner to one of said contact elements of said cell pole connector;
said contacting web including at least one web segment extending obliquely in relation to said cell pole contacting plane of said cell pole contact element.

2. The contacting system according to claim 1, wherein one or more of the following is true:
said board contact element is a platelet;
said board contact element is at least partially at a distance from said cell pole contacting plane;
said board contact element is aligned substantially parallel to said cell pole contacting plane;
said board contact element and said contacting web are formed on a side facing away from a cell pole contacting surface of said cell pole contact element;
said board contact element and said contacting web extend when considered in plan view at least partially outside said cell pole contact element;
said contacting web and said board contact element connected thereto extend transversely to a connecting line of two adjacent said cell pole contact elements of the respective said cell pole connector.

3. The contacting system according to claim 2, wherein:
said platelet being said board contact element has a rectangular, square or oval board contacting surface;
a board contacting surface of said board contact element is at least partially spaced apart from said cell pole contacting plane; or
said contacting web and said board contact element connected thereto extend perpendicularly to the connecting line of two adjacent said cell pole contact elements of the respective said cell pole connector.

4. The contacting system according to claim 1, wherein at least one of the following is true:
said contacting web is formed in one piece with at least one said cell pole contact element of the respective said cell pole connector;
said contacting web comprises two web segments, which are aligned obliquely in relation to the cell pole contacting plane;
said contacting web is a contact strip.

5. The contacting system according to claim 4, wherein at least one of the following is true:
said two web segments are approximately parallel to one another and have a U-shaped profile in sections perpendicular to the cell pole contacting plane, with a straight, curved or wave-form base; or
said contacting web is a contact strip having a flat cross section and i is curved or wave-form;
wherein a width measured in the longitudinal direction of the contact strip is less than a correspondingly measured width of said cell pole contact element and/or of the said board contact element.

6. The contacting system according to claim 1, wherein:
two said cell pole contact elements of at least one said cell pole connector of the contacting system in a respectively one-piece form are connected to one another by way of a wave portion that is formed to compensate for stresses selected from the group consisting of tensile stresses, flexural stresses, and torsional stresses of said cell pole connector, with at least one wave crest or at least one wave trough; and/or
said cell pole contacting surfaces of said cell pole contact elements of at least one said cell pole connector are situated in a common cell pole contacting plane, board contacting surfaces of at least two board contact elements being situated in a common board contacting plane.

7. The contacting system according to claim 6, wherein said cell pole contacting plane and said board contacting plane extend parallel to one another.

8. The contacting system according to claim 1, wherein at least one of the following is true:
said web segment comprises an abutting surface for the abutment of a board connected to said board contact element or another component of the contacting system;
said web segment comprises, at least on a side facing away from the respective said cell pole contact element, at least one latching element for locking a board that is connected to said board contact element;
at least one of said board contact element or said web segment is configured as a supporting element for a board connected to said board contact element.

9. The contacting system according to claim 8, wherein said abutting surface faces away from the respective said cell pole contact element.

10. The contacting system according to claim 1, wherein:
said cell pole connector is formed of a plurality of layers comprising at least two layers of material; and
said contacting web is connected in one piece with that layer of material which, given proper electrical connection, is connected directly to the cell poles.

11. The contacting system according to claim 10, wherein said cell pole contact elements are formed with a plurality of layers comprising at least two layers of material.

12. The contacting system according to claim 1, which further comprises a supporting frame and wherein:
said at least one cell pole connector is mechanically fastened to said supporting frame;
said at least one cell pole connector comprises a fastening component configured for fastening to said supporting frame and formed for connection to said supporting frame, wherein said fastening component optionally has at least one through-hole aligned perpendicularly to the cell pole contacting plane, wherein, by way of the through-hole, said cell pole connector is optionally connected to the supporting frame by a riveted connection and/or a caulking, and wherein, on a side that is facing away from said fastening component, said cell pole connector is also optionally in engagement by means of at least one latching element formed on said supporting frame.

13. The contacting system according to claim 12, wherein:
said supporting frame has a supporting element for at least one board contact element comprising at least one supporting projection, said board contact element being supported with a side facing away from said board contacting surface of said board contact element on said supporting element.

14. The contacting system according to claim 13, wherein said supporting element is one of a plurality of supporting elements one for each board contact element.

15. The contacting system according to claim 1, comprising:
at least one row of cell pole connectors with in each case a plurality of cell pole connectors arranged parallel to a longitudinal axis of the contacting system and disposed one behind the other, wherein the cell pole connectors of a row of cell pole connectors are aligned in such a way that connecting lines of the cell pole contact elements of the cell pole connectors are in each case oriented parallel to a longitudinal axis of the row of cell pole connectors; and/or
wherein cell pole connectors of a row of cell pole connectors are aligned such that a unit formed by said contacting web and said board contact element extends transversely to the longitudinal axis of said row of cell pole connectors and/or of the contacting system;
wherein said board extends parallel to the longitudinal axis of said row of cell pole connectors and/or of the contacting system.

16. The contacting system according to claim 15, wherein:
said cell pole connectors of a row of cell pole connectors are aligned in such a way that connecting lines of the cell pole contact elements of the cell pole connectors are in each case oriented parallel to a longitudinal axis of the contacting system, and/or
said the unit formed by said contacting web and said board contact element extends perpendicularly to the longitudinal axis of said row of cell pole connectors and/or of the contacting system;
said rows of cell pole connectors are formed in pairs and said cell pole connectors of a pair of rows of cell pole connectors are aligned in such a way that the board contact elements of one row of cell pole connectors are facing the board contact elements of another row respectively of said cell pole connectors; and
wherein said board extends substantially over an entire longitudinal extent of the rows of cell pole connectors and/or parallel to the rows of cell pole connectors.

17. The contacting system according to claim 15, further comprising:
a board with a plurality of board contacts, a number of board contacts optionally corresponding to the number of board contact elements, and each board contact being directly connected in an electrically conducting manner to a board contact element, in particular by a material-bonding connection;
wherein said board is arranged between two rows of cell pole connectors and board contact elements facing said board are in electrical contact with corresponding board contacts, and said board abutts with at least one longitudinal edge against the web segments of the respective contacting webs, and/or said board is at least partially supported on said board contact elements by way of said board contacts.

18. The contacting system according to claim 1, further comprising at least one electrical interface formed at a longitudinal end of the contacting system, comprising at least one plug-in contact element, the at least one electrical interface comprising at least one power tap and/or control tap; and
wherein the interface is formed in such a way that the plug-in direction of the interface extends parallel to a longitudinal axis of the contacting system.

19. An energy storage device, comprising:
a plurality of energy storage cells each having cell poles of opposed polarity;
at least one contacting system according to claim 1;
said cell pole connectors of said contacting system electrically interconnecting said cell poles of at least one subset of said energy storage cells.

20. The energy storage device according to claim 19, wherein:
said energy storage cells are electrochemical storage cells;
said cell poles of said energy storage cells are electrically connected in series,
wherein electrical contact surfaces of the cell poles interconnected with a contacting system are situated in a common cell pole contacting plane;
board contacting surfaces of said board contact elements are situated in a common board contacting plane;
said cell pole contacting plane and said board contacting plane are arranged parallel to one another, and wherein when considered in a direction of a cell pole normal of said cell poles, said board contacting plane is disposed above said cell pole contacting plane.
